(19) United States
(12) Patent Application Publication
(10) Pub. No.: US 2010/0129542 A1
(43) Pub. Date: May 27, 2010

(54) VERFAHREN UND VORRICHTUNG ZUM BESCHICHTEN ZUMINDEST EINES TEILES EINES SUBSTRATES

(75) Inventor: Peter Weingartner, Dölsach (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: DURST PHOTOTECHNIK DIGITAL TECHNOLOGY GMBH, Lienz (AT)

(21) Appl. No.: 12/619,845

(22) Filed: Nov. 17, 2009

(30) Foreign Application Priority Data
Nov. 25, 2008 (AT) A 1845/2008

(51) Int. Cl. B05D 1/12; B05D 1/36; B05C 5/00

(52) U.S. Cl. 427/185; 427/266; 118/313

(57) ABSTRACT

The invention relates to a method and a device for coating at least one portion of a glass and/or ceramic substrate (2). In the latter output devices (5, 12, 22-25) are assigned to an application device (1) controlled by a control device (16). Said output devices (5, 12, 22-25) are assigned holding containers (18, 19) for holding a particle fluid (8, 26) and a pigment fluid (10, 27). The particle fluid (8, 26) and the pigment fluid (10, 27) are applied in a previously coordinated manner in terms of time and spatial distribution onto the substrate (2) to be coated.

The invention relates to a method and a device for the multicoloured printing of a glass and/or ceramic substrate according to the preamble of claims 1 and 28.

A method that has been used for many years for printing glass and/or ceramic products is screen printing. In this method the printing ink is pressed by a rubber squeegee, a wiper-like tool, through a close-meshed textile fabric onto the material to be printed. The parts of the textile fabric which are not to be printed according to the picture motif are made impermeable to ink by means of a template. The templates are produced by means of a photochemical treatment for example: the textile fabric is covered with a photosensitive emulsion and dried. Afterwards the textile fabric is radiated with UV-light by a positive and the photosensitive emulsion hardens according to the motif. The unexposed emulsion is removed by washing, the template is then ready for printing. Ceramic colour pastes are used for printing. The latter are produced in that one or more colouring components are stirred together with fluxing agents and if necessary additives (fillers, dispergents) in a suspension means, for example screen printing oil. The viscosity of the screen printing oil is in the range of 3×10³ mPa to 10×10³ mPA. The colouring component consists of inorganic pigments and the latter have the required stability for the stoving process. The fluxing agent consists essentially of glass frit, and the latter is produced by melting and then quenching a glass mass. Glass frit is usually an intermediate product in the production of glass melts. The thus produced crumbly-porous material is ground, whereby 50 vol. % of the particles are larger than 10 μm. Glass frit is also used as the raw material for producing vitreous enamel. The fillers can be used to improve the physical and chemical properties of the ceramic colour. Screen printing pastes for printing glass consist of about 80% inorganic materials (pigments, fluxing agents) and up to about 20% organic materials (suspensions, diluents, dispergents). The inorganic materials consist in turn of about 80% fluxing agents and about 20% pigments. The viscosity of the screen printing paste is in the region of 10⁴ mPa. After applying the colour paste onto the glass or ceramic product to be decorated the stoving process begins: in this case the glass frit softens and forms a glass flux on the surface of the product to be printed. In said gas flux the additives (pigments) are embedded and fixed onto the product surface. This process takes place in the case of glass as the material to be printed below the deformation temperature at about 630° C.

Although good results can be achieved with screen printing it also has some disadvantages. The production of the template, which is necessary before printing, takes up a certain amount of time, the method is slow compared to digital industrial inkjet printing, which is being used more frequently due to the flexibility of the method. However, there are limitations which oppose the use of inkjet printers for glass and/or ceramic products: whilst screen printing pastes have a viscosity of in the region of 10⁴ mPa, the viscosity of an inkjet ink has to be less than 15 mPa and 90 vol. % of the particles have to be less than 1 μm. Only in this way can a good printing resolution be ensured. Owing to the various thicknesses and surface properties of the two inorganic components (fluxing agent and pigment) it is very difficult to keep these two components stable in a low-viscosity medium: it exhibits a significant inclination to sedimentation and agglomeration. These undesired processes can only be partly prevented by adding various additives.

A method addressing these deficiencies is described in patent document DE 199 21 925 A1. This method for decorating solid materials, in particular materials suitable for firing, comprises applying a decorative layer which has a base of a (thermoplastic) colour paste containing a pigment and a thermoplastic medium onto a surface of the material to be decorated by means of direct or indirect printing. The colour paste contains at least 30 wt. % inorganic inks from a series of pigments, glass frits and other glass-forming components and is printed by means of inkjet technology, whereby the colour paste is held by a heatable inkjet writing head, the temperature of which is kept above the melting point of the colour paste, on the surface of the material to be decorated or a transfer material is applied. Surprisingly, according to the invention melted thermoplastic colour pastes, as used for decorating glass container, with a very high content of inorganic solids exhibit almost no sedimentation. After switching off the heating in the inkjet writing head and/or in the supply element of the inkjet printing device the thermoplastic colour paste hardens straight away, so that no sedimentation occurs even over a long working life. The disadvantage is that all of the containers and lines have to be heated together with the inkjet writing head which requires higher levels of energy.

The underlying problem of the present invention is to develop a method and a device for coating a glass and/or ceramic substrate, which enables high quality digital application with fluids suitable for firing or glazing in a reliable manner and using a small amount of energy.

This problem is solved in a method for the multicoloured printing of a glass and/or ceramic substrate in which an application device controlled by a control device is assigned output devices and holding containers for holding a particle fluid and a pigment fluid, in that particle fluid and pigment fluid are applied with a previously coordinated time and dimensional specification on the substrate to be coated.

By means of the invention it is possible to simplify the application of particle fluids and pigment fluids and make it more rapid and more precise, whereby the fixing of such fluids by firing, sintering on glass and ceramic products can be considerably improved. In addition, the sedimentation or agglomeration of the components of fluids is avoided during the preparation and application, in that the fluids with different inorganic particles or pigments are applied separately onto the substrate to be coated. In this way it is possible to stabilise the different inorganic particles or pigments in various fluids, as particles or fluxing agents and pigments are only mixed on the substrate to be coated.

A further measure is advantageous in which the particle fluid and the pigment fluid are applied simultaneously onto different positions of the portion of the surface of the substrate to be coated, as positioning is possible by adhesion in an intermediate drying process or drying off and thus a precise positioning of the drops of the fluid can be achieved.

Extremely good mixing and colouring of the particles and pigment is achieved in a procedure in which the particle fluid and at least one pigment fluid are applied in a previously determinable sequence in the same position of the part of the surface of the substrate to be printed.

In a further variant of the method of the invention it can be advantageous if drops of the particle fluid and drops of at least one pigment fluid are applied on top of one another. In this way the pigments can be mixed thoroughly with the fluxing agent.

The production of multicoloured motifs can be improved considerably if the drops of several pigment fluids are applied so as to overlap one another at least partly.

Also a variant of the method is advantageous in which the drops of particle fluid are applied so as to overlap on one or more drops of at least one pigment fluid, as in this way the moisture or liquid contained in the pigment fluid can be used for fixing the particles of the particle fluid.

In a further advantageous process sequence of the invention the application of pigment fluids and particle fluids on top of one another is performed in a wet-on-wet technique. In this way the optimum mixing can be achieved, which results in the effective incorporation of pigments in the glaze.

In a further advantageous procedure of the invention during the application of a multicoloured motif firstly the particle fluid and then the pigment fluid is applied. In this way an exact colour point can be set.

According to a further advantageous development of the method for coating the object with a multicoloured motif firstly the drops of at least one pigment fluid and then the drops of the particle fluid are applied, whereby a motif applied onto the object can be protected by the protective layer of particle fluid applied on top which can be sintered or melted onto the object.

A precise image can be achieved in that by placing several colour points of pigment fluid consisting of several base colours next to one another, simultaneously or consecutively a coloured image point of the motif is applied onto the particle fluid or the surface.

According to one variant of the measures according to the invention it is also possible for the particles of the particle fluid to be applied by a fluid formed by a gas onto the fluid drops of the pigment fluid, as in this way the particles can be positioned more precisely on the surface of the object.

Furthermore, according to a further development of the method it is also possible for particles of the particle fluid to be added to a fluid formed by a liquid, and for the specific weight or the specific density of the fluid and the particles to be almost identical, thereby enabling the uninterrupted processing of the particle fluid, as sedimentation and agglomeration are prevented in this way, as the particles which are distributed evenly in the liquid maintain their position relative to one another or change their position only slightly by rising or sinking In this way processing is achieved with output devices with fine jets and thereby an exact positioning of the fluid drops is achieved with high availability.

It is advantageous if the difference between the specific weight and the specific density between the fluid and the particle of the particle fluid lies within a range of +/−20%, preferably +/−5 to 10%, as in this way it is possible to achieve extremely good working properties for the particle fluid.

According to a further measure of the invention it is advantageous if the viscosity and the specific weight of the fluid is adjusted relative to the specific weight of the particles, such that the relative speed between the particles and the fluid is close to zero.

According to a further variant of the method the viscosity and the specific weight of the fluid relative to the specific weight of the particles is adjusted such the sinking speed of the particles in the fluid of the particle fluid is between 0.1 and 20% preferably 0.1 to 10% of gravitational acceleration, as in this way it is also possible to avoid sedimentation of the particles in the fluid even with smaller movements of the fluid.

In this connection it can also be an advantage if the viscosity and the specific weight of the fluid is adjusted in relation to the specific weight of the particles such that the buoyancy speed of the particles in the fluid of the particle fluid is between 0.1 and 10% of the gravitational acceleration, as in this way separation can be prevented by the particles rising too rapidly in the fluid.

To achieve optimum fluxing properties and a drop size which increases the precision it is possible for the pigment fluid used to have a viscosity of less than 15 mPa.

According to a development of the method to ensure better flow properties the particle fluid, when used in the operation of an application device, can have a carrier liquid in the form of a fluid, which contains fluxing agents in the form of particles, and also a dispersing agent and a diluting fluid, in order to improve the toughness and/or the viscosity of the particle fluid.

According to further advantageous measures of the invention the particles of the particle fluid are made of glass or ceramic or the base material for producing glass or ceramic.

In this case it is advantageous if the particles of the particle fluid are formed by plastics, metal or non-metal materials. It is advantageous when using such particles that the particles are melted and plasticised by simple heating or power supply via laser, electron beam, light air or hot air and thus can be bonded permanently onto the substrate, however it is also possible to melt said particles onto the substrate.

It is also advantageous however, if the particles of the particle fluid are made from glass frits, as this material is particularly suitable for coating glass and/or ceramic products or preproducts of ceramic products, namely blanks, as thus in a simple manner a resistant glazing can be produced by firing.

To achieve optimum fluxing properties of the fluxing agent 50 wt. % of the glass frit particles can have a diameter of less than 5 μm, preferably less than 2 μm. In this way it can be ensured that the pigments are completely surrounded and thus that the surface of the printed and fired decoration has a high quality.

For performing the present method and applying the coating it is advantageous if the fluid drops of the output device for the particle fluid are ejected in a volume of between 20 to 70, preferably 50 picolitres.

To achieve a high quality colour the pigment fluid can have inorganic dye pigments. The latter are stable unlike most organic pigments even at high firing temperatures and are also more resistance to ageing.

According to the invention 90 wt. % of the colour pigment particles have a diameter of 0.5 to 4 μm, preferably less than 1 μm. In this way good flowability and high colour intensity can be combined.

The present objective of the invention can however also be achieved independently by a device for printing a surface of a fixed, preferably glass and/or ceramic substrate comprising an application device with a control device, at least one output device with several holding containers assigned to the output device for a pigment fluid and a particle fluid, as well as a positioning device for positioning the substrate to be printed, if the at least one application device is provided with separate output devices and holding containers for a particle fluid and a pigment fluid.

The main advantage of this device is that the particle fluid and the pigment fluid are transported and applied separately. The fluids can therefore be better adjusted to the different physical properties of these materials, and therefore compared to the use of a single mixture the risk of sedimentation or agglomeration during processing can be considerably reduced.

In a constructive embodiment of the invention the output devices for the particle fluid and for the pigment fluid are arranged behind one another in the supply direction of the substrate to be printed. By means of this arrangement it is possible that the thus achievable application speeds are not below those of an inkjet printer with a simple output device.

Further advantageous embodiments of the invention can be taken from the further claims and the associated advantages given in the description.

The invention is explained in more detail with reference to the following drawings: the latter show:

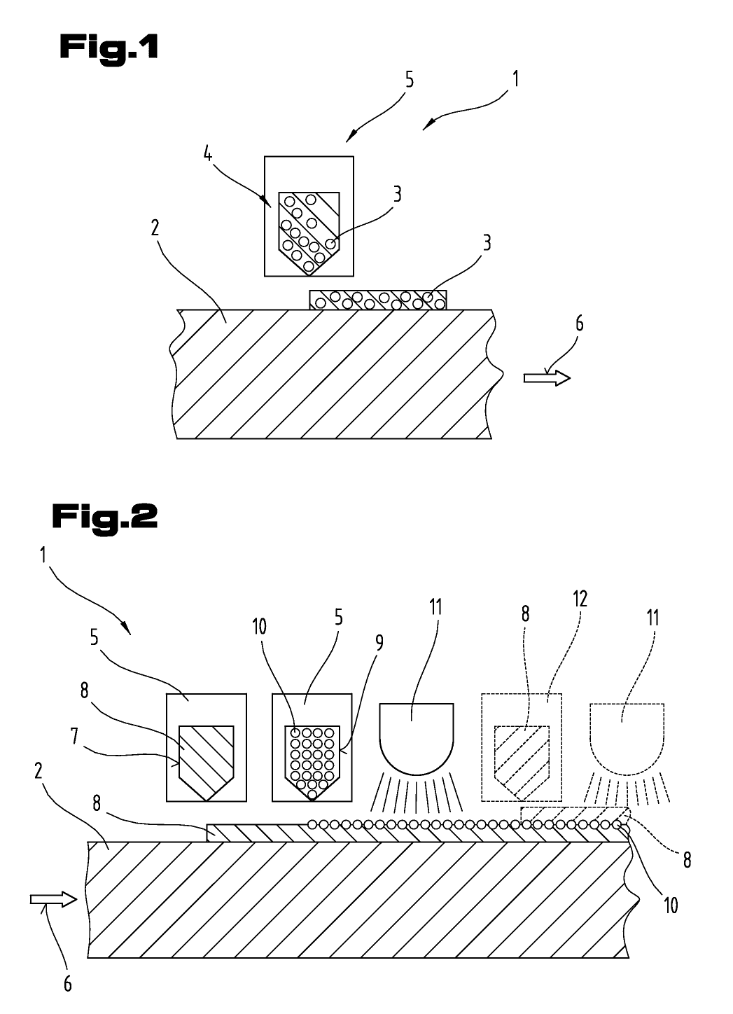

FIG. 1 a main view of the multicoloured coating of a glass or ceramic substrate with an application device for fluids;

FIG. 2 a main view of the method according to the invention for the multicoloured coating of a glass or ceramic substrate;

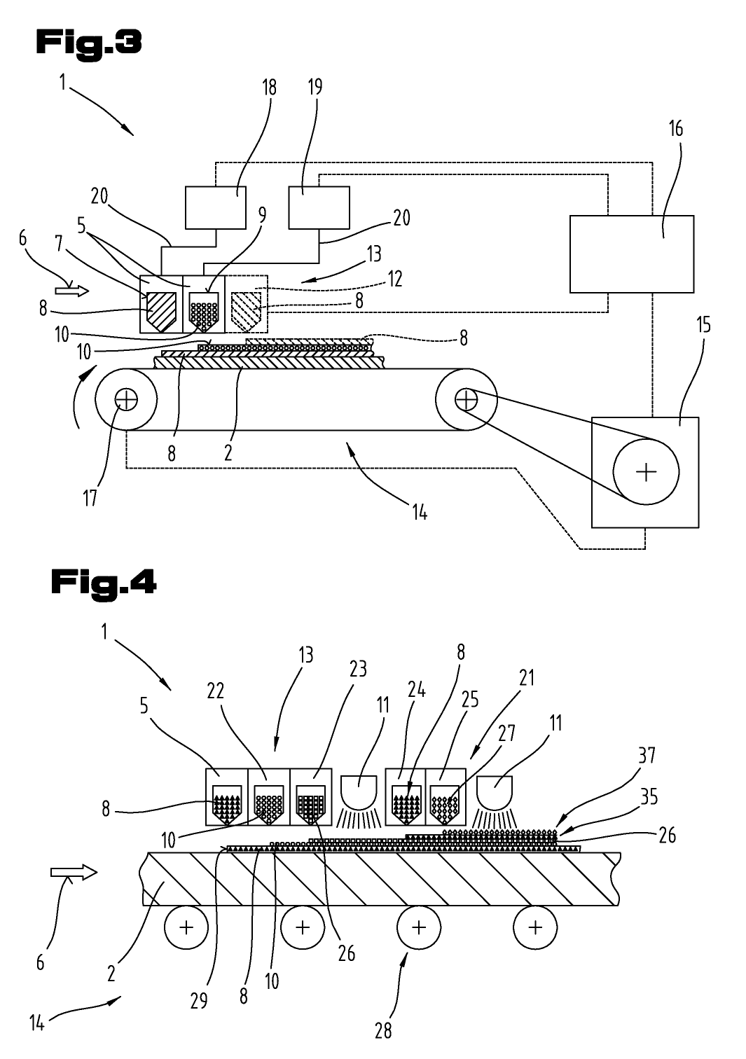

FIG. 3 a schematic view of an application device for performing the method according to the invention;

FIG. 4 another embodiment of an application device for performing the method according to the invention with several output devices for fluid drops in side view and in a much simplified schematic view;

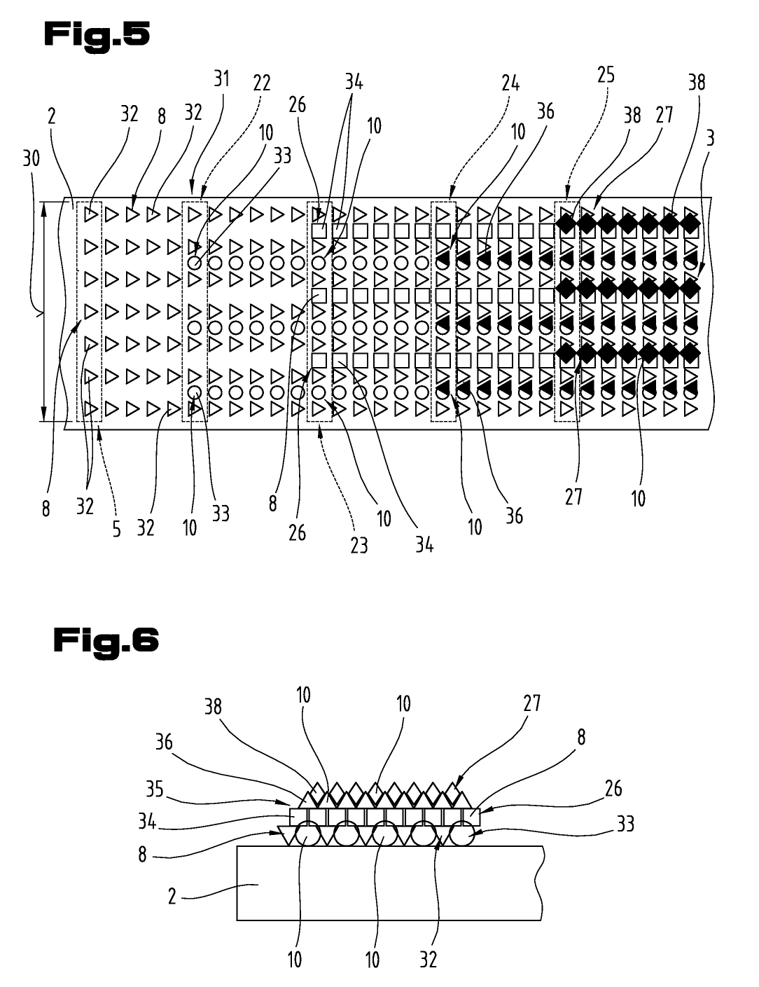

FIG. 5 a schematic view of the fluid drops applied according to the method of the invention in plan view;

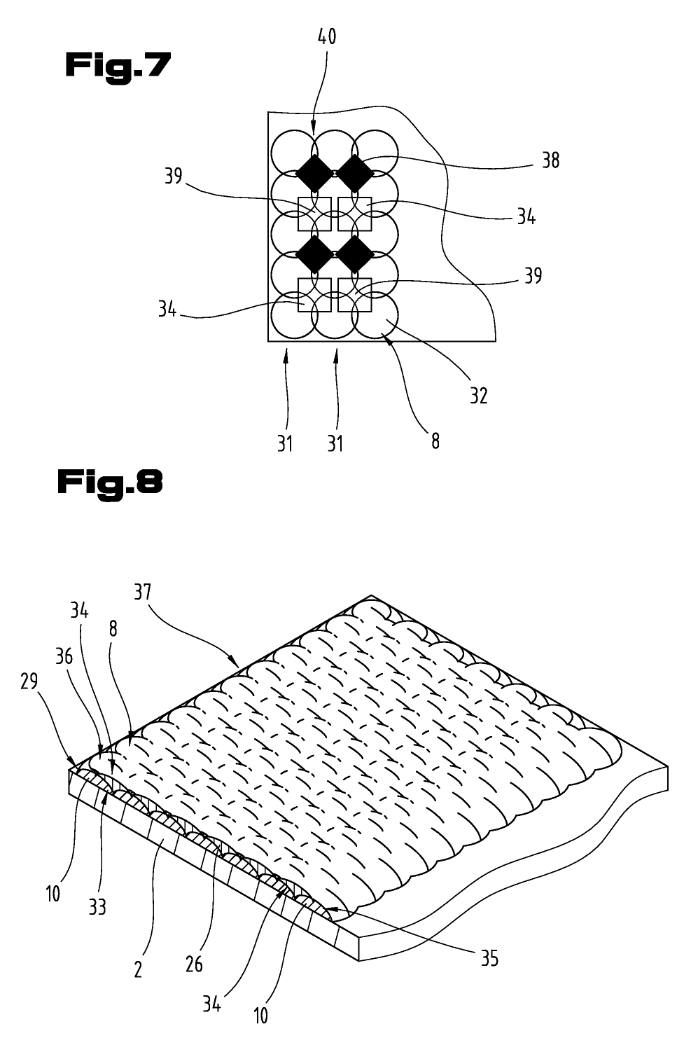

FIG. 6 an arrangement produced by the method according to the invention of the various fluid drops in several layers on top of one another in side view and in a much simplified, schematic view;

FIG. 7 an arrangement produced by the method according to the invention of the various fluid drops in several layers on top of one another in plan view and in a much simplified, schematic view;

FIG. 8 an arrangement produced by the method according to the invention of the various fluid drops in several layers on top of one another in a graphical and much simplified, schematic representation in a cross sectional end view;

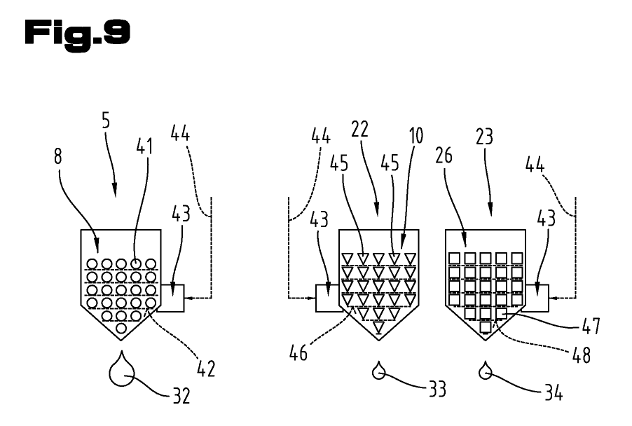

FIG. 9 the output devices for fluid drops of the application device according to FIG. 4 in a much simplified schematic view.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

Whilst a device for performing the method according to the invention allows multicoloured printing, the drawings shown here are limited for the purpose of simplifying the representation to one printing colour.

The application device 1 shown in FIG. 1 for coating a substrate 2 by applying a fluid 3 functions in its operating principle according to the previous prior art. Only one jet 4 of an output device 5 for the fluid 3 is provided. The jet 4 or the output device 5 and the substrate 2 to be coated move relative to one another at least in one advancing direction—arrow 6. In addition, it is possible that the output device 5 with the jets 4 is also moved perpendicular to the advancing direction—arrow 6—and if it is a so-called scanning application device 1, whereby the advance of the substrate 2 to be coated is performed intermittently, that is after the movement of the output device 5 over the entire width of the substrate 2 at right angles to the advancing direction—arrow 6.

The following embodiments of the methods and devices according to the invention apply to so-called single-pass applications of the output device 5, in which the output device 5 and the output devices 5 possibly consisting of one or more groups for all required colours and the particles to be applied extend over the entre maximum possible width of the substrate 2 to be coated, i.e. also for the so-called scanning application device 1, in which the output devices for the different fluids extend only over a portion of the width of the substrate 2 and the application of the ink is performed in strips, preferably with a stationary substrate 2.

Furthermore, it is also possible to use an output device 5 in which the drops of fluid 3 after leaving the output device 5 are diverted by an electromagnetic field, so that they hit the right point of the substrate 2 to be printed.

The substrate 2, on which the motif 11, such as e.g. a lens raster image, a three-dimensional motif, a decorative strip or wood grain, is to be applied, can be made from different materials, for example film-like materials made of paper, plastic, metal, textiles, wood and the like or fleece, net and the like or even board-like material such as e.g. MDF boards, melamine boards, a glass component, plywood, veneer, plastic board, cardboard and strip-like material from the above materials. It is possible in particular to print board-like material or components or films of wood, for example also with a wooden structure different from said wood, ceramic, such as ceramic components as fired products or also as blanks, natural stone or other natural materials such as mats, nets, fleeces or leather and other materials such as for example plasterboard, plaster components or the like or apply a three dimensional structure 2.

The application device 1 according to the invention shown in FIG. 2 for performing the method of the invention has a jet 7 for applying a particle fluid 8 and a jet 9 for applying a pigment fluid 10. The jets 7, 9 and the substrate 2 to be printed perform a relative movement to one another in the direction of arrow 6, such that firstly the particle fluid 8 and then the pigment fluid 10 is applied. With this arrangement of jets 7 and 9 it is possible to apply the particle fluid 8 and the pigment fluid 10 simultaneously from jets 7, 9 of immediately adjacent output devices 5. In this way it is possible to apply the two fluids 8, 10 in a wet-on-wet technique.

In an advantageous manner it is possible for the pigments of the pigment fluid 10 to sink at least partially into the still wet particle fluid 8 and preferably during the subsequent hardening—performed for example by means of power supply via a drying device 11 for example a UV-light emitting lamp or an infrared device or other heat radiating device—is dried and the pigments of the pigment fluid 10 can be fixed in the flowing ink 8. However, it is also possible in this way to achieve optimum mixing between the particle fluid 8 and the pigment fluid 10, firstly to apply one or more pigment inks 10 and to apply a particle fluid 8 on and/or between the latter at least in individual areas, which results in the effective incorporation of the pigments by the particles or fluxing agent, whereby during firing the result is a perfect glaze.

Furthermore, it is also possible to apply the particle fluid 8 and the pigment fluid 10 by means of output devices 5, 12, which have a greater distance in the direction of the relative movement according to arrow 6. Thus it is possible for example for the output devices 5, 12 for the particle fluids 8 and pigment fluids 10 to be arranged in separate single-pass application devices 5, 12 arranged one behind the other, or it is also possible that separate scanning application devices 1 are provided and the output devices 5, 12 for the pigment fluid 10 are located on a different scanning application device 1, such as the output device 1 for the application of particle fluid 8.

It is advantageous in the design of application devices 1 consisting of several groups 13 of output devices 5, 12, if the latter are equipped if necessary with replaceable rapid-coupling devices for supplying the fluid and the energy supply and control lines, so that in the case of the failure of the individual output devices 5, 12 the latter can be replaced rapidly for new output devices 5, 12. Also the arrangement of the individual output devices 5, 12 in adjacent rows which are offset relative to one another in the longitudinal direction of the rows, is also advantageous in single pass application devices 1 or scanning ones.

Depending on the desired resolution it is also possible for the output devices 5 to be arranged obliquely to the relative movement direction—arrow 6—as can be taken from the prior art, for example WO 2006/084614 A1, and with respect to the application end of the different drops of fluid from AT 411 975 A of the same applicant. The content of these disclosures in WO 2006/084614 A1 and AT 411 975 A is included hereby as a disclosure in this description for completion.

By arranging the output devices 5, 12 at a predefined distance behind one another it is also possible to control the drying state of the particle fluid 8 such that e.g. the pigments of the pigment fluid 10 only adhere lightly to the surface but can no longer sink into the layer of particle fluid 8.

In this connection it can be advantageous, following the output devices 5 for the particle fluid 8 and the pigment fluid 10 to provide a further output device 12 indicated by dashed lines in the drawings, by means of which more particle fluid 8 can be applied, so that via the pigment fluid 10 an additional layer of particle fluid 8 or pigment fluid 10 can be applied. In the case of additionally applying a further particle fluid 8 or pigment fluid 10 onto the pigment fluid 10 the device for supplying energy 11 can also be arranged before or after said additional output device 12.

FIG. 3 shows a schematic view of another device according to the invention for performing the method according to the invention. The application device 1 functions preferably according to the continuous inkjet principle usual in industrial applications, i.e. with a continual inkjet The application device 1 is assigned a positioning device 14 by means of which the substrate 2 to be printed is fed to a group 13 of the output device 5, 12 of the application device 1, which can consist of several output devices 5 or 12 or also several groups 13 of such output devices 5 or 12.

In the present case the group 13 is indicated only schematically and extends over the entire width of the substrate 2 to be printed and therefore is suitable for a single-pass coating, in which the group 13 i.e. also the output devices 5, 12 are stationery and the substrate 2 to be printed is moved through by the positioning device 14 below the output device 5, 12 in conveying direction—arrow 6.

Said positioning device 14 is preferably formed by a continuous conveyor belt which is guided over at least two guiding rollers. The positioning device 14 is driven by a drive device 15. The drive device 15 is preferably an asynchronous motor, which can be controlled by means of a frequency converter which is connected in turn to the control device 16. Of course, it is also possible to provide any other drive device or other electric motors or drive elements with both analogue and digital controls for controlling the advance with the positioning device 14. The belt speed can be determined by an only schematically indicated sensor 17 which sends its measuring signal to the control device 16. If necessary the belt speed can be adjusted in this way.

Preferably, at the belt run-in a lateral guide or a centring device is arranged which can be adjusted to the respective width of the substrate 2 to be printed and by means of which the substrate 2 can be aligned precisely in all desired dimensions.

The substrate 2 to be printed can thus be guided so exactly on the endless conveyor belt that it is centred laterally relative to the output devices 5, 12 with high precision, e.g. a tolerance of less than +/−1 mm.

Of course it is also possible with the required extremely precise positioning to guide the substrate 2 laterally precisely over the entire length at least of the output devices 5, 12 or to arrange on the positioning device 14 precisely positioned mounts for the substrate 2. In this way it is possible to position the drops of fluid precisely at least on the part of a surface of the substrate 2 to be printed.

Further output devices 5, 12 for several colours, not shown here, can be arranged behind one another in the supply direction—arrow 6.

To produce a multicoloured motif or image it is possible to build up a coloured image point on the particle fluid 8 by placing next to one another several fluid drops of pigment fluid 10 in several base colours, whilst the substrate 2 to be coated is moved on by the positioning device 14. The direction of movement is indicated by the arrow 6.

This allows colour to be applied in a single pass of the substrate 2 to be coated so that high coating speeds can be achieved.

The output devices 5 comprise jets 7, 9 for the application of the fluid drops of the particle fluid 8 and the pigment fluid 10 onto the substrate 2 to be coated.

Supplies of the corresponding particle fluids 8 and pigment fluids 10 are kept in holding containers 18, 19. In said holding containers 18, 19 said fluids are brought and held at the temperature required for processing in the output devices 5, 12 and said fluids 8, 10 are kept moving by pumping processes or stirring tools or ultrasound application, so that the fluids 8, 10 and the particles or pigments mixed into the fluids cannot separate out.

In this way it is possible as in the prior art to feed said fluids 8, 10 via supply lines 20 in the circuit through the respective jets 7, 9, so that an even distribution of the particles and pigments in the fluids can be ensured. The control of the temperature and the movement of fluids in the holding containers 18, 19 and in the supply lines 20 or jets 7, 9 can be charged and/or monitored by the control device 16.

Likewise, the filling levels in the holding containers 18, 19 are monitored by the control device.

The jets 7, 9 are provided with corresponding output devices or drives which bring about the ejection of drops of fluids 8, 10 onto the substrate 2 to be coated. By means of the output devices via the drive of the control device 16 fluid drops with varying volumes can be delivered to the positions selected by an image data evaluation or recognition device onto the parts of the surface o the substrate 2 to be coated. The application devices can be provided with a drive such as a piezo drive, a valve jet drive, an electrostatic, thermal or acoustic drive for applying the drops of fluids.

If necessary the substrate with the applied pigment or particle fluids 8, 10 can be fed into a following drying or hardening device 11 or a firing device for melting on or a sintering device for sintering on at least the inorganic particles of the pigment fluid.

FIGS. 4 and 5 show a further embodiment variant of an application device 1. Said application devices 1 comprises group 13 and an additional group 21 which can be equipped with several output devices 5, 22 and 23 and 25.

The number of output devices 5, 22 to 25 arranged behind one another in conveying direction—arrow 6—can be determined, according to the desired colours to be applied onto the substrate 2 to be coated or the corresponding number of particle fluids 8, 26 or pigment fluids 10 or 27.

In the present case the substrate 2 is moved for example on a roller track 28 of the positioning device 14 under the preferably stationary application device 1.

The substrate supplied in conveying direction—arrow 6—moves firstly under the application device 5 and a layer 29 of the particle fluid 8 is applied onto the substrate.

As can best be seen from FIG. 5, the width 30, which can correspond to the width of the substrate 2 or as in the shown exemplary embodiment can also be smaller than the width of the substrate 2, is the one over which fluid drops 32 from particle fluids 8 are applied by means of the output device 5 for example in a line 31.

In conveying direction—arrow 6—then by means of the output device 22 fluid drops 33 of the pigment fluid 10 are applied for example in the individual part areas over the printing width 30 of the substrate 2. Then further fluid drops 34 of a further particle fluid 26 are applied by the output device 23, whereby for example the individual fluid drops 34 of the pigment fluid 10 or 27 can be arranged offset relative to one another, so that between the fluid drops 32 of the pigment fluid 10 one fluid drop 34 of the pigment fluid 26 can be placed.

Afterwards it is possible by means of the additional output device 24 to apply over the applied fluid drops 34 of the particle fluid 26 a layer 35 of fluid drops 36 of the pigment fluid 6, in order for example to apply cavities located between the individual fluid drops or the fluid points 32, 33 formed therefrom on the substrate 2 either in the intersection between four adjacent fluid drops 32, 33 or corresponding fluid points on the substrate 2 or between the individual fluid drops 32, 33, 34 or the fluid points formed from the latter in the individual rows 31 or between two rows 31 arranged behind one another.

It is shown only by way of example that afterwards on said layer 35 of pigment fluid 10 by means of the output device 25 a further layer 37 of fluid drops 38 of an additional pigment fluid 27 can be applied partially or covering the surface on the underlying layer 35 or 29.

According to the desired coating or build up of glaze various layers 29, 35, 37 of particle fluids 8, 26 and/or pigment fluids 10, 27 can be applied, e.g. wet-on-wet on the substrate 2 to be coated in any sequence of pigment inks 10, 27 and/or particle fluids 8, 26 or vice versa. Of course, it is also possible, as indicated for example by an energy supply device 11 for example by means of energy beams such as UV light or the like to undertake the intermediate drying of the applied fluids 8, 10, 26, 27, before the next layer 29, 35, 37 of particle fluid 8, 26 or pigment fluid 10, 27 is applied.

For this also for example separate energy devices 11 can be arranged between the individual output devices 5, 22, 23 or 24, 25.

By means of the possibility of stabilising different inorganic portions e.g. of pigments in different fluids to produce different colours it is possible to apply a plurality of different colour effects or material combinations by means of the application device 1, which otherwise cannot be mixed together or cannot be mixed in a stable manner so that they can be applied by output devices 5, 12, 22-25.

Said output devices 5, 12, 22-25 can according to the so-called inkjet print heads known in the industry and used in large quantities can be applied distributed onto the substrate with the fluids also mixed with pigments. It is advantageous if the diameters of the jets of the output devices 5, 12, 22-25 are adapted to the density as well as the dynamic and/or kinematic viscosity of the pigment fluids 10, 27 or particle fluids 8, 26. Furthermore, it is also possible to provide in addition or in sections output devices 5, 12, 22-25 with varying jet diameters so that fluid drops 32-34 and 36 can be applied in varying volumes or the particles or pigments can have a different grain size.

The advantage of arranging various output device 5, 22, 23, 24, 25 behind one another to apply different fluxing agents or particles and/or pigment fluids 8, 26; 10, 27 is that particles, e.g. fluxing agents and pigments are mixed only on the substrate 2 or only come into contact with one another then.

Owing to the many different ways in which the individual drops 32-34, 36, 38 of particle fluid 8, 26 and/or pigment fluid 10, 27 can be arranged next to one another partly overlapping, in the intermediate spaces between the individual fluid drops or points 32-24, 36, 38 can overlap one another completely, an enormous variety of different layers 29, 35, 37 can be produced, which could not be produced with the previously known methods.

Of course, on applying said ink points of fluid drops 32-34, 36, 38 all of the methods known from the Austrian patent AT 411 957 B, such as for example interlacing, interleaving, are used for applying the various particle fluids 8 or pigment fluids 10, 26, 27 in which fluid drops are printed only on individually selected points within one line 31, i.e. with intermediate spaces, in which no fluid drops are applied.

FIG. 5 shows for example that via a line 31 fluid drops 33 of pigment ink 10 are applied only at specific points onto the underlying layer 29 of fluid drops consisting of fluid points 32 formed by particle fluid 8 by means of the output device 22.

By means of the following output device 23 then a different mixture and a different form or a differently composed particle fluid 26 can be applied, for example in the intermediate spaces between the fluid drops or points 33 of the line 31 as indicated schematically for example by the fluid drops 34.

It is essential in this case that the individual fluid drops 32, 33, 34 are provided according to the control device 16 or the colour or image or raster data provided by the corresponding software program.

On the additional layer 35 of fluid drops 36 of the pigment fluid 10, which is applied by the output device 24, a further layer 37—FIG. 4—of fluid drops 38 or points of pigment fluid 27 can be applied by the output device 25 partly or over the entire width 30 continuously in more or less close arrangement next to one another or contacting one another directly or overlapping at least partly.

In this way it is also possible to apply onto various points of the substrate 2 various layers 29, 35, 37 of particle fluid 8, 26 and/or pigment fluid 10, 27 in order to achieve different effects of a designer, colour or physical composition.

Also by means of the corresponding selection of droplet size i.e. the volume of the individual fluid drops 32-34. 36, 38 the surface on the substrate 2 covered by the resulting ink points and their layer thickness and thus also the layer thickness of the individual layers 29, 35, 37 are adjusted to the corresponding requirements. Thus it is possible for example to embed pigments of the pigment fluids 10, 27 completely into a layer of particle fluid 8, 26 or to incorporate the latter only partially into the particle fluid 8, 26.

Also the mixing and the mixing ratios between the particle fluid 8, 6 and the pigment fluid 10, 27 can be achieved by the varying droplet size of the fluid drops 32-34, 36, 38 or by layering them next to one another of on top of one another or the partially overlapping arrangement of the thus formed fluid points. It is also possible after each layer 29, 35, 37 of pigment fluid 10, 27 to apply a layer of particle fluid 8, 26 partially or so as to cover the surface.

FIGS. 6 and 7 show schematically further possibilities for arranging the individual fluid drops 32-34, 36, 38 of particle fluid 8, 26 or pigment fluid 10, 27. In this way as shown schematically in the representation in FIG. 6, the volume size i.e. the volume of the individual fluid drops 32-34, 36, 38 or the droplet size for forming the fluid points can be predetermined and controlled by the control device 16. In this way it is also possible to control more effectively the size of the fluid points 38 formed by the fluid drops 32, 33, 34, 36 and their overlayering and covering. Thus it is possible that onto the overlapping area of the fluid drops 32 of particle fluid 8, 26 the fluid drops 33 of pigment fluid 10, 27 can be applied.

Of course, it is also possible to apply the fluid drops directly on top of one another, as shown by way of the ink drops 33 and 36 in FIG. 6.

From the view in FIG. 7 it can be seen that the individual fluid drops 32 of the particle fluid 8 are arranged to overlap one another in all directions, so that there is either no more or only a minimum amount of free space between the four fluid points in two adjacent rows 31.

For example, only one row 40 formed by fluid points 34 of the particle fluid 26 and fluid points 38 of the pigment fluid 27 can be applied on top of one another, so that the row 40 is positioned centrally between the longitudinal middle lines of the rows 31, whereby it can also be seen that the fluid drops 38 and 34 can be positioned alternately in the intersection of four underling fluid drops 32 of the particle fluid 8.

FIG. 8 shows schematically a view partly in cross section of a further and if necessary separate embodiment of the arrangement and the overlapping of the various fluid drops 32 to 34, whereby for the same parts the same reference numbers or component names are used as in the preceding FIGS. 2 to 7. In order to avoid unnecessary repetition reference is made to the detailed definition in the preceding FIGS. 2 to 7.

In this case firstly fluid drops 33 of the pigment fluid 10 are applied onto the substrate 2 until they overlap slightly at least in the longitudinal direction of the substrate 2.

Onto said layer 29 of fluid drops 33 as indicated schematically in the present case in longitudinal direction offset by the half scale, fluid drops 34 consisting of a particle fluid 26, e.g. with about the same volume as the fluid drops 33, are applied into the intermediate spaces between the individual fluid drops 33.

Over this layer 35 of fluid drops 34 then a further layer 37 of fluid drops 36 of pigment fluid 10, 27 is applied. The latter are applied into the remaining intermediate spaces between the fluid drops 34. Of course, it is also possible to determine the volume of the fluid drops 36 so that the latter cover not only the intermediate spaces between the individual fluid drops 34 of the particle fluid 26, but in addition lower fluid drops 36 with a smaller volume are applied onto the outermost surface of the fluid drops 34 of the particle fluid 26, so that both layers 35 and 37 are covered completely by the layer of fluid drops 36.

Of course, any other possible arrangement and position of the individual fluid drops or points of the different layers 25, 35, 37 of particle fluid 8, 26 or pigment fluid 10, 27 are possible within the scope of the invention and as known from the prior art.

Also the composition of the particle fluids 8, 26 and pigment fluid 10, 27 used in the rows 31, 40 and/or layers 29, 35, 37 or different layers can differ.

The properties and the composition of the pigment fluids 10 and the particle fluids 8 which are to be applied onto the substrate are particularly important for the present invention.

For this reason the output device 5, 22, 23 of the application device according to FIG. 4, which form a group 13, are shown on a larger scale.

As can be seen in these drawings the particle fluid 8 provided for application from the output device 5 consists of particles 41 and a fluid 42—indicated schematically by dashed lines.

The fluid 42 can for example be a gas, for example air, or different liquids, such as for example water, hydrocarbons, glycerine, oils, such as for example paraffin oil or olive oil.

According to the invention for the application of inorganic particles or preferably inorganic pigments different fluids, namely a particle fluid 8 or a pigment fluid 9 is used. For applying fluid drops 32 the output device 5 is assigned a drive 43, which can be connected via a control line 44 to the control device 16.

In the same way the additional output devices 22, 23 are provided with corresponding drives 43, which can be connected via control lines 44 to the control device 16.

The output device 22 is designed for delivering a pigment fluid 10, which is formed by a mixture of preferably inorganic pigments 45 and a fluid 46. Of course, it is possible when using the application device 1, that with such a group 13 of output devices 5, 22, 23 a plurality of output devices 22 is provided for pigment fluids 10 with different pigments for producing the different colours, namely the base colours cyan, magenta, yellow, black and white.

In conveying direction-arrow 6—a further output device 23 for supplying a particle fluid 26 is arranged after the output device or devices 22.

The particle fluid 26 consists for example of particles 47 other than particles 41 and the same fluid 48 or one different from fluid 42.

Furthermore, it is shown in this drawing that the output devices 22 for supplying fluid drops 32 can be designed for example to have a larger volume than the fluid drops 33 and 34.

The size of said fluid drops 32, 33, 34 and their volume determine the amount or volume of the particles 41, 47 or pigments 45 to be applied onto the substrate 2. It is an advantage here if the fluid drops have a volume of between 20 and 70 preferably 50 picolitres. To produce fluid drops 32 to 34, 36, 38 with a suitable volume it is now possible to charge the drives 43 via the control device 16 for varying lengths of time, so that fluid drops 32-34, 36, 38 are formed with a larger volume or it is also possible to use output devices with different jets, that is jets with different bore or jet diameters. The use of jets with different cross sections or different bore diameters can also make it possible to add to the particle fluids 8, 26 or pigment fluid 10, 27 particles 41, 47 or pigments 45 with varying diameters or grain sizes or different grading curves to the respective fluid 42, 46 or 48.

Such particles for example glass frit particles can have an average diameter of <5 μm and preferably <2 μm. The colour pigment particles can have a different average diameter of 0.5 to 4 μm preferably a diameter or grain size of <1 μm.

With respect to the particles 41, 17 or pigments 45 to be used in the particle fluids 8, 26 it should be taken into consideration that both fibrillary, i.e. fibrous particles 41, 47 or pigments 45 or spherical particles 41, 47 can be used. When using fibrillary particles 41, 47 or pigments 45 or powder it should be taken into consideration that they can make the flow behaviour of the liquid or the fluid 42, 46, 48 to which they are added shearing-dependent, that is change the liquid or the fluid towards a non-Newtonian behaviour. This can, for example when using particle fluids 8, 26 as well as so-called ink for printing ink, make their use more difficult. Spherical particles 41, 47 or pigments 45 or the powder of spherical particles 41, 47 however flows much better and can be conveyed, metered and dispersed more easily. With particles 41, 47 or pigments 45 with a fibrillary structure it should also be taken into consideration that for example by entanglement or another type of bonding of smaller more fibrillary particles or pigments 45 even larger fibrillary particles or pigments 45 can be formed. It is advantageous if the spherical particles 41, 47 or pigments 45 have an irregular surface or no fibrous fraying or fibrils. In addition, the bulk density of spherical particles 41, 47 or pigments 45 or the powder of such particles for can contribute technical advantages, as such particles 41, 47 or pigments 45 or the powder allows greater compactness and also better flowability, mixability in various media and easy storage.

The diameter of the jets may however not be oriented or not entirely oriented to the grain size or the diameters of the particles 41, 47 or pigments 45, but can be influenced exclusively or at least partly depending on the fluids used 42, 46, 48.

For this mainly the dynamic and the kinematic viscosity of the various fluids 8, 10, 26, 27 or their specific weight should also be considered or considered exclusively.

In order to achieve the advantages according to the invention, which can be created by separating the fluids into a particle fluid 8, 26 or a pigment fluid 10, 27, the toughness and the specific weight as well as the dynamic viscosity or the toughness and the kinematic viscosity of the fluids 42, 46, 48 and the specific weight of the particles 41, 47 or the pigments 45 have to be adjusted relative to one another. Since usually the specific weight of the particles 41, 47 required for the particle fluid 8, 26 is very different from the specific weight of the pigments 45 required for the pigment fluid 10, 27, the present invention by separating the two fluids makes it possible to set the kinematic viscosity and toughness according to the specific weight of the particles 41, 47 or pigments 45 so that the specific weight or the density of the fluid 42, 48; 46 or the particles 41, 47; 45 is almost the same.

However, it also possible for the difference between the specific weight or the density between the fluids 42, 48; 46 and the particles 41, 47 or pigments 46 to be in a range of from +/−20% preferably +/−5% to 10%.

If the specific weight or the densities of the fluid 42, 48; 46 and the particles 41, 47 or pigments 46 are almost the same it is assumed that the produced distributed mixture of the particles 41, 47 or pigments 46 into the fluid 42, 46, 48 over a specific period does not change purely theoretically or adopts and almost stable state. In this way sedimentation or agglomeration or sinking or separation of the particles 41, 47 or pigments 45 are prevented or at least reduced, so that during the usual movement of fluids during processing by pumping between the different tanks and the output devices 5, 12, 22 to 25 an even distribution of particles 41, 47 or pigments 25 can be achieved in the fluids 42, 46, 48 and can be maintained at least for the period required for processing.

Then if a continual mixing or movement of the fluids 42, 46, 48 can be ensured by stirring or continual pumping, it is also possible to use the difference between the specific weights of the fluids 42, 48; 46 and particles 41, 47 or pigments 45 in a range of +/−20% preferably in a range of +/−5% to 10%.

Since with fluids, in particular liquids, the viscosity for the sinking or rising or separating of particles 41, 47 or pigments 45, the so-called viscosity has to be included, according to the solution according to the invention it is an advantage that the viscosity and the specific weight of the fluid 42, 48; 46 is set in a ratio to the specific weight of the particles 41, 47 or pigments 45 such that the relative speed between the particles 41, 47 or pigments 45 and the fluid 42, 48; 46 is close to zero. This ratio between the viscosity and the specific weight between the dynamic viscosity and the specific weight is usually also referred to as the kinematic viscosity. Since the different fluids or mainly liquid fluids have very different viscosity values for the dynamic viscosity, which can move in ratio of 1.0 mPa in water at 20° C. to 10² to 10⁶ mPa in paraffin oil or 1,480 mPa in glycerine, a person skilled in this field can produce a fluid from the existing fluids with the addition of corresponding thinning agents or mixing different liquid fluids, the kinematic viscosity of which or viscosity in relation to the specific weight of the particles 41, 47 or the pigments 45 is such that the particles 41, 47 or pigment 45 distributed by mixing evenly in a specific amount of fluid remain distributed evenly in the fluid as long as possible. This has the advantage that many particles 41, 47 or pigments 45 can only be achieved without complex additional pumping and treatment methods such as ultrasound or the like to maintain a homogenous mix between the fluids 42, 46, 48 and the particles 41, 47 or pigments 45.

The same applies to the pigments 45 in the fluids 46.

It is mainly advantageous within the scope of the invention, if it is ensured that the kinematic viscosity of the fluid is set in a ratio to the specific weight of the particles 41, 47 or pigments 45, so that the sink speed of the particles 41, 47 or pigments 45 in the fluids 42, 48, 46 is between 0.1% and 30%, preferably 0.1% to 10% of the gravitational acceleration. The same applies to the buoyancy speed of the particles 41, 47 or pigments 45 in the fluids 41, 48; 46.

It is also an advantage if a pigment fluid 10, 27 has a viscosity of less than 15 mPa.

Mainly determining the kinematic viscosity of fluids 42, 46, 48 is an advantage if a fluxing agent for example particles of glass or ceramic or parent substances are used as the particles 41, 47 for producing glass and ceramic or glass frits. The same also applies to the use of plastics or metal or non-metal materials.

With particles 41, 47 or glass frit particles it is an advantage if at least 50% have an average diameter of less than 5 μm, preferably less than 2 μm. In this way it is possible to use liquid fluids, the viscosity values of which still allow the simple handling of the particle fluids 8, 26 or pigment fluids 10, 27, for example on pumping round or pumping through the output devices 5, 12, 22 to 25. On setting the kinematic viscosity of the liquid fluids it should be ensured that the viscosity is not too high as otherwise the ejection of fluid drops 32 to 34, 36 and 38 is no longer ensured or can no longer be ensured with the thin jet bores or the output devices 5, 12, 22, to 25 or in some circumstances the temperatures required for processing the particle fluids 8, 26 or pigment fluids 10, 27 are too high, since as already known the viscosity of fluids falls with rising temperatures.

In general it should be noted that the viscosity, regardless of whether it is dynamic or kinematic viscosity, changes with the temperature of the fluid 42, 46, 48. Accordingly with the arrangement of the particle fluids 8, 26 or pigment fluids 10, 27 the required and expected operating temperature of the application device 1 or the output devices have to be taken into account or the temperature adapted to the desired values for the required viscosity of the fluid 8, 10, 26, 27.

During the processing of the pigments 45 of the pigment fluid 10, 27 it is advantageous to use inorganic colour pigments, as inorganic colour pigments also allow higher processing temperatures, and the inorganic pigments retain their colour intensity particularly if particles 41, 47 are to be bonded by sintering, melting or by another heat treatment to the underlying layers on pigment fluids 10, 27 or particle fluids 8, 26 or the substrate 2.

It is however also obvious during the processing of particle fluids 8, 26 which do not require processing temperatures for bonding with the fluid drops of the other layers or the substrate 2, to use organic pigments.

With the pigments 45 it is an advantage if between 80 and 95%, preferably at least 90 wt. % of the pigments 45 have an average diameter of 0.5 μm to 4 μm, preferably less than 1 μm.

The exemplary embodiments show possible embodiment variants of the arrangement of the fluid drops or fluid points and the output device and the groups 13, 21 formed therefrom, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

In a further and possibly independent embodiment, the same reference numbers and component names are used for the same parts as in the preceding FIGS. 2 to 7. To avoid unnecessary repetition reference is made to the detailed description in the preceding FIGS. 2 to 7.

Finally, as a point of formality, it should be noted that for a better understanding of the structure of the device and its components and the ink points or drops the latter have not been represented true to scale in part and/or have been enlarged and/or reduced in size.

Mainly the individual embodiments shown in FIGS. 2; 3; 4; 5; 7; 8 can form the subject matter of independent solutions according to the invention. The objectives and solutions according to the invention relating thereto can be taken from the detailed descriptions of these figures.

### LIST OF REFERENCE NUMERALS

1 Application device 41 Particle

2 Substrate 42 Fluid

3 Fluid 43 Drive

4 Jet 44 Control line

5 Output device 45 Pigment

6 46 Fluid

7 47 Particle

8 48 Fluid

9 9 Jet

10 Pigment fluid

11 Device for power supply/drying device

12 Output device

13 Group

14 Positioning device

15 Drive device

16 Control device

17 Sensor

18 Holding container

19 Holding container

20 Supply line

21 Group

22 Output device

23 Output device

24 Output device

25 Output device

26 Particle

27 Pigment fluid

28 Roller track

29 Layer

30 Width

31 Row

32 Fluid drop

33 Fluid drop

34 Fluid drop

35 Layer

36 Fluid drop

37 Layer

38 Fluid drop

39 Free space

40 Row

1. A method for coating at least one portion of a preferably glass and/or ceramic substrate in which output devices are assigned to an application device controlled by a control device and the output devices are assigned holding containers for holding a particle fluid and a pigment fluid, wherein the particle fluid and the pigment fluid are applied in a previously coordinated manner in terms of time and spatial distribution onto the substrate to be coated.

2. The method according to claim 1, wherein the particle fluid and the pigment fluid are applied simultaneously to different positions of the part of the surface of the substrate to be coated.

3. The method according to claim 1, wherein the particle fluid and at least one pigment fluid are applied in a previously determinable sequence on the same position of the part of the surface of the substrate to be printed.

4. The method according to claim 1, wherein the particle fluid and at least one pigment fluid are applied so as to overlap one another at least partly.

5. The method according to claim 1, wherein several pigment fluids are applied to the substrate and at least partially overlap one another at least partly.

6. The method according to claim 1, wherein the particle fluid is applied so as at least partly overlap on at least one pigment fluid.

7. The method according to claim 1, wherein the pigment fluid and the particle fluid are applied wet-on-wet.

8. The method according to claim 1, wherein to apply a multicoloured motif firstly the particle fluid is applied and then afterwards at least one pigment fluid is applied.

9. The method according to claim 4, wherein for the multicoloured coating of the object with a motif first the fluid drops of at least one pigment fluid is applied and then the particle fluid is applied.

10. The method according to claim 1, wherein placing several fluid drops from the pigment fluid simultaneously or consecutively next to one another a coloured image point of the motif consisting of several base colours is applied onto the fluid drops of the particle fluid or a surface of the substrate.

11. The method according to claim 1, wherein particles of the particle fluid are applied with a fluid formed by a gas onto the fluid drops of the pigment fluid.

12. The method according to claim 1, wherein particles of the particle fluid are added to a fluid formed by a liquid and in that the specific weight or the density of the fluid and the particles is almost identical.

13. The method according to claim 1, wherein the difference between the specific weight or the density of the pigment fluid between the fluid and the particle or pigment of the particle fluid lies in a range of +/−20% preferably +/−5 to 10%.

14. The method according to claim 1, wherein the viscosity and/or the specific weight of the fluid relative to the specific weight of the particles or pigment are coordinated with one another such that the relative speed between the particle or pigment and the fluid is close to zero.

15. The method according to claim 1, wherein the viscosity and/or the specific weight of the fluid relative to the specific weight of the particles or pigment are coordinated with one another such that the sink speed of the particles or pigment in the fluid of the particle or pigment fluid is between 0.1 and 30%, preferably 0.1 to 10% of gravitational acceleration.

16. The method according to claim 1, wherein the viscosity and the specific weight of the fluid relative to the specific weight of the particles or pigment are coordinated with one another, such that the uplift speed of the particles or pigment in the fluid is between 0.1 and 30% preferably 0.1 to 10% of the gravitational acceleration.

17. The method according to claim 1, wherein the pigment fluid has a viscosity of less than 15 mPa.

18. The method according to claim 1, wherein the particle fluid comprises a fluxing agent as particles and a carrier fluid as fluid.

19. The method according to claim 1, wherein the fluid of the particle fluid in addition to the carrier fluid contains a dispersing agent and a thinning agent.

20. The method according to claim 1, wherein the particles of the particle fluid are made of glass or ceramics or of the parent substances for producing glass or ceramic.

21. The method according to claim 1, wherein the particles of the particle fluid are made of plastic, metal or non-metal materials.

22. The method according to claim 1, wherein the particles of the particle fluid are made from glass frit.

23. The method according to claim 1, wherein at least 50% of the particles or glass frit particles have an average diameter of less than 5 μm, preferably less than 2 μm.

24. The method according to claim 1, wherein fluid drops of the output device for the particle fluid are ejected in a volume of between 20 and 70, preferably 50 picolitres.

25. The method according to claim 1, wherein pigments of the pigment fluid are formed by inorganic colour pigments.

26. The method according to claim 1, wherein at least 90 wt. % of the colour pigment particles have an average diameter of 0.5 to 4 μm, preferably less than 1 μm.

27. The method according to claim 1, wherein the output devices are arranged to move almost perpendicular to guiding tracks running towards one another and the application device is arranged to moved in two dimensions running substantially perpendicular to one another in a plane running parallel to the bearing surface of the positioning device.

28. A device for coating at least one portion of a surface of a substrate comprising an application device with at least one output device with several holding containers assigned thereto for a pigment fluid and a particle fluid, a positioning device with a bearing surface for the substrate to be coated opposite the application device with a control device for controlling the application device, the positioning device, wherein the application device is designed to have separate output devices for the particle fluid and the pigment fluid, whereby each of said output devices is connected to the associated holding container for the particle fluid or the pigment fluid.

29. The device according to claim 28, wherein the output devices or their jets for the particle fluid and or the pigment fluid are arranged in the conveying direction of the substrate to be printed by the positioning device.

30. The device according to claim 28, where the output devices or their jets for the particle fluid and for the pigment fluid are arranged behind one another in the direction of movement of the output devices.

31. The device according to claim 28, wherein the output devices are arranged to be fixed over the entire width or the part of the width of the substrate to be coated.

32. The device according to claim 28, wherein the output device and the substrate to be coated are designed and arranged to be adjustable relative to one another at least in one dimension.

33. The device according to claim 28, wherein the output devices extend over only a part of the width or the part of the width of the substrate to be coated and the output devices are arranged to move at right angles to the coated part of the surface of the substrate.

34. The device according to claim 28, wherein the output devices are arranged to move almost perpendicular to guiding tracks running towards one another and the application device is arranged in two dimensions that are substantially perpendicular to one another in a plane running parallel to the bearing surface of the positioning device.
